(19) United States
(12) Patent Application Publication
(10) Pub. No.: US 2024/0051326 A1
(43) Pub. Date: Feb. 15, 2024

(54) RAMAN-DETECTIBLE COMPOSITIONS COMPRISING 2D MATERIALS

(71) Applicants: THE UNIVERSITY OF SUSSEX, Bringhton Sussex (GB); ADVANCED MATERIAL DEVELOPMENT LIMITED, Guildford (GB)

(72) Inventors: Peter LYNCH, Brighton (GB); Alan DALTON, Brighton (GB); Sean OGILVIE, Brighton (GB); Matthew LARGE, Brighton (GB); James JOHNSTONE, Guildford Surrey (GB)

(21) Appl. No.: 18/033,908

(22) PCT Filed: Oct. 29, 2021
(86) PCT No.: PCT/GB2021/052805

§ 371 Date: Apr. 26, 2023

(30) Foreign Application Priority Data
Oct. 29, 2020 (GB) 2017172.4
Oct. 30, 2020 (GB) 2017225.0

(51) Int. Cl. B42D 25/378; G07D 7/1205; B42D 25/29; G01N 21/65; C09D 11/037; C09D 11/033; C09D 11/106

(52) U.S. Cl. CPC B42D 25/378; G07D 7/1205; B42D 25/29; G01N 21/65; C09D 11/037; C09D 11/033; C09D 11/106; G07D 2207/00

(57) ABSTRACT

The invention provides a Raman-detectible composition comprising two or more different Raman-active 2D materials. Also provided is a formulation comprising the Raman-detectible composition and a binder; a substrate comprising the Raman-detectible composition; the use of the Raman-detectible composition to tag a substrate; a method for tagging a substrate with the Raman-detectible composition; and a method for analysing a substrate or formulation for the presence of the Raman detectible composition.

### FIELD OF THE INVENTION

This invention relates to Raman-detectible compositions and to formulations and substrates comprising the Raman-detectible compositions. The Raman-detectible compositions comprise two or more different Raman-active 2D materials. The invention also relates to inks comprising the formulation, the use of the Raman-detectible compositions to tag a substrate, methods for tagging a substrate with the Raman-detectible compositions, and methods for analysing a substrate or formulation for the presence of the Raman-detectible compositions.

The invention also relates to methods of generating a code based on the 2D material content of a material, methods of verifying the authenticity of an article, and an apparatus for verifying the authenticity of articles.

### BACKGROUND OF THE INVENTION

The United Nations Office on Drugs and Crime describes counterfeiting as “a crime which touches virtually everyone in one way or another”. The implications of counterfeiting for product quality assurance and reliability undermines confidence in the origins, quality and safety of products. Robust labelling provides a route towards global traceability and enforcement. However, many existing authentication technologies for distinguishing sources of materials (such as conventional barcodes, QR codes, RFID tags and luminescent dyes) can be either obscured, tampered with or removed as they are not integral to the material itself. These existing technologies can also be impossible or impracticable to implement for small objects.

Raman spectroscopy is a laser-based technique for probing the vibrational structure of molecules that allows for the detailed profiling of chemical composition. Tagging products with Raman-active materials therefore presents an alternative method for authentication of products to existing technologies.

EP 2,714,419 A discloses the use of Raman markers for product authentication. Compositions comprising at least two types of Raman-active nanoparticles are disclosed, wherein each of the Raman-active nanoparticles is either in a dispersed state or in the form of an agglomerate containing 2-500 nanoparticles and having a size of less than 2 μm. This document discloses that the nanoparticles in the dispersed state have a different Raman signature to the agglomerated nanoparticles. The preferred nanoparticle materials are silicon, Co₃O₄, Ce₂O₃, TiO₂, X(W₃)₄ and XNbO₃, wherein X is an alkaline, alkaline earth, transition metal, or lanthanide element. EP 2,714,419 A does not disclose use of 2D materials as the Raman-active nanoparticles.

US2006/0038979 A and US 2007/0165209 disclose nanoparticle tags that are detectible by surface enhanced Raman spectroscopy for authentication purposes. The nanoparticles comprise a Raman-enhancing metal nanoparticle, a Raman-active molecule (also referred to therein as a reporter molecule) that is attached to or associated with the surface of a nanoparticle, and an encapsulating material. The use of 2D materials as the Raman-active material is not disclosed.

Gu et al., “Gap-enhanced Raman tags for physically unclonable anticounterfeiting labels”, Nature Comms, 2020, 11:516 describes anticounterfeiting labels which make use of the Raman spectra of thiolated aromatic molecules attached to gold nanospheres. The use of 2D materials is not disclosed.

There remains a need to provide Raman-detectible compositions which can provide a large number of characteristic and resolvable Raman spectra using a relatively low number of different Raman-active materials.

It would also be desirable to be able to disperse Raman-detectible compositions homogeneously throughout the bulk of a material so that the characteristic Raman signature can be detected even if only fragments of articles made from the material are available for analysis. This would enable application of Raman-detectible compositions for tracing sources of waste, such as ocean (micro)plastic waste.

### SUMMARY OF THE INVENTION

The presence of 2D layered nanomaterials can be determined by Raman spectroscopy. The inventors of the present application have developed a range of nanomaterial-containing compositions, formulations and materials that can be used as tags/barcodes for authentication purposes based on the Raman spectrum of the nanomaterials within the composition, formulations and materials. Methods for generating a unique code based on the nanomaterial content of the tag/barcode material have also been developed.

The invention is based on the processing of 2D nanomaterials into composites and coatings and the well-defined peaks of their vibrational spectra, which allows these materials to be combined to give Raman-readable authentication markers which cannot be removed, damaged or altered. A code calculated from the type and quantity of nanomaterials present using a Raman spectrometer can then be used to verify the authenticity of the product carrying the Raman-readable authentication marker. The nanomaterial-containing material therefore encodes a unique fingerprint/code that can be determined using Raman spectroscopy and used to verify the authenticity of the product.

In one aspect, the invention provides a Raman-detectible composition comprising two or more, preferably three or more, different Raman-active 2D materials.

In another aspect, the invention provides a formulation comprising a Raman-detectible composition and a binder; wherein the Raman-detectible composition comprises two or more, preferably three or more, different Raman-active 2D materials.

In another aspect, the invention provides a substrate comprising a Raman-detectible composition comprising two or more, preferably three or more, different Raman-active 2D materials, wherein:

(i) the Raman-detectible composition is homogeneously dispersed within the substrate, and wherein the substrate is not a metal; or

(ii) the Raman-detectible composition is on the surface of the substrate.

Where the Raman-detectible composition is on the surface of the substrate, an overcoat of protective material may be disposed over the Raman-detectible composition.

In another aspect, the invention provides use of a Raman-detectible composition comprising two or more, preferably three or more, different Raman-active 2D materials to tag a substrate. The invention also provides use of the formulation of the invention to tag a substrate.

In another aspect, the invention provides a method for tagging a substrate with a Raman-detectible composition comprising two or more, preferably three or more, different Raman-active 2D materials (or with a formulation of the invention), the method comprising:

(i) dispersing the Raman-detectible composition within the substrate, wherein the substrate is not a metal; or

(ii) applying the Raman-detectible composition (e.g. in the form of the formulation of the invention) to the surface of the substrate.

In another aspect, the invention provides a method for analysing a substrate or formulation for the presence of a Raman detectible composition comprising two or more, preferably three or more, different Raman-active 2D materials, the method comprising:

(i) subjecting the substrate or formulation to Raman spectroscopy, and

(ii) analysing the Raman spectrum for the presence of a Raman signal that is characteristic of the Raman-detectible composition. The method of this aspect may be a computer-implemented method. The substrate or formulation preferably comprises the two or more different Raman-active 2D materials. For example, the formulation may be a formulation of the invention as defined herein or the substrate may be a substrate of the invention as defined herein.

In another aspect, the invention provides a method of generating a code based on the 2D material content of a material, the method comprising:

a) measuring and obtaining the Raman spectrum of the material, wherein the material comprises two or more, preferably three or more, different Raman-active 2D materials;

b) comparing the obtained Raman spectrum with reference data for each of the two or more different 2D materials in order to determine the presence, and optionally the quantities, of the two or more different 2D materials;

c) generating a code based on the presence, and optionally the quantities, of the two or more different 2D materials.

Based on this code, the authenticity of an article bearing/containing the 2D materials can be verified.

Accordingly, in one aspect the invention provides a method of verifying the authenticity of an article, the method comprising:

a) generating a code according to a method described herein;

b) comparing the generated code with a known code to determine the authenticity of the article.

In a further aspect, there is provided an apparatus for verifying the authenticity of articles, the apparatus comprising:

(a) a Raman spectrometer, the spectrometer comprising a laser light source and a detector;

(b) an electronic data store for storing known Raman reference data of two or more, preferably three or more, different Raman-active 2D materials;

(c) an electronic data processor for comparing the Raman spectrum obtained by the spectrometer and the Raman spectra in the electronic data store; and

(d) an output device for indicating to the user either:
i) a code derived from the obtained Raman spectrum; or
ii) an indication of the authenticity of the article.

Features disclosed herein in relation to one aspect of the invention are explicitly disclosed in combination with each of the other aspects of the invention.

### LIST OF FIGURES

FIG. 1A shows the Raman spectra of five Raman-active 2D materials (graphene, hexagonal-boron nitride [h-BN], molybdenum disulphide [MoS₂], tungsten disulfide [WS₂] and molybdenum diselenide [MoSe₂]) and of Raman-detectible compositions comprising different combinations of these 2D materials. Raman spectra of each of these five 2D materials individually are shown in the top left graph. The Raman spectrum of a Raman-detectible composition containing all five of these 2D materials is shown in the top right graph. The middle right graph shows a Raman spectrum of a Raman-detectible composition containing graphene, hexagonal boron nitride, tungsten disulfide and molybdenum diselenide. The bottom right graph shows the Raman spectrum of a Raman-detectible composition containing the same combination of 2D materials as the middle right graph, but in different relative amounts.

FIG. 1B shows a Venn diagram showing the 15 binary permutations for different mixtures that can be obtained by combining up to four different types of nanomaterials.

FIG. 2 shows the Raman spectra of MoS₂ (lower trace in both the upper and lower graphs), WS₂ (middle trace in both the upper and lower graphs), and MoSe₂ (top trace in both the upper and lower graphs) on a Si substrate. The top spectra was obtained using a 532 nm laser and the bottom using a 660 nm laser.

FIG. 3 shows the Raman spectra of a control formulation containing PVP (bottom trace in both graphs) and reference formulations comprising: PVP and MoS₂ (lower middle trace in both graphs), PVP and WS₂ (upper middle trace in both graphs) and PVP and MoSe₂ (top trace in both graphs). The laser wavelength was 660 nm for the upper graph and 532 nm for the lower graph. The formulations were drop cast on a silicon wafer.

FIG. 4 shows the Raman spectra of a formulation comprising Raman-detectible compositions of the invention and polyvinylpyrrolidone (PVP). The Raman-detectible compositions contained MoS₂ and WS₂ (top trace in both the upper and lower graphs), and MoS₂, WS₂ and MoSe₂. The laser wavelength was 660 nm for the upper graph and 532 nm for the lower graph. The formulations were drop cast on a silicon wafer.

FIG. 5 shows the Raman spectra of an untreated cotton fibre (bottom trace), a cotton fibre on which a control formulation comprising PVP has been deposited (middle trace), and a cotton fiber on which a reference formulation (top trace) comprising PVP and MoS₂ has been deposited. The laser wavelength was 660 nm.

FIGS. 6-8 show Raman spectra for a cotton fiber on which MoS₂ (FIG. 6), graphene (FIG. 7) and graphene oxide (FIG. 8) have been deposited. In FIGS. 7 and 8 the bottom traces are for an untreated cotton fibre and the top traces are for a cotton fiber on which the 2D material has been deposited. The laser wavelength was 532 nm for the MoS₂ sample, and was 785 nm for the graphene and graphene oxide samples.

FIG. 9 shows Raman spectra for an untreated cotton fiber, a cotton fiber coated with a paraffin layer and a cotton fiber coated with a paraffin layer comprising graphene. Spectra were acquired using a 785 nm laser.

FIG. 10 shows the intensity for the Raman shifts (both E and A vibrational modes) exhibited by MoS₂, WS₂ and combinations thereof.

FIG. 11 shows the normalised intensity for the Raman shifts exhibited by MoS₂, WS₂ and combinations thereof.

FIG. 12 shows the intensity for the Raman shifts exhibited by graphene, boron nitride, MoS₂, WS₂ and a combination containing all four of these nanomaterials.

### DETAILED DESCRIPTION OF THE INVENTION

As used herein the term “Raman-detectible composition” means a composition that is detectible by Raman spectroscopy.

The Raman-detectible compositions described herein comprise two or more different Raman-active 2D materials. The use of two or more different 2D materials in the Raman-detectible compositions enables the production of a large number of unique compositions having characteristic Raman spectra or signatures.

These characteristic signatures can be considered to be tags, barcodes or labels, which can be applied onto or incorporated into a substrate to enable the substrate to be identified and tracked. For example, the tags can be incorporated or impregnated into a substrate which can be attached to or form the whole or part of the article. Alternatively, the tag may take the form of a printable barcode which can be printed onto a substrate, which again can be attached to or form part of the article.

In other words, a material containing different types of 2D materials (e.g. nanoplatelets) encodes a unique fingerprint/code that can be determined using Raman spectroscopy and used to verify the authenticity of a product. A code calculated from the type and quantity of 2D materials/nanoplatelets present using a Raman spectrometer can then be used to verify the authenticity of the product carrying the Raman-readable authentication marker.

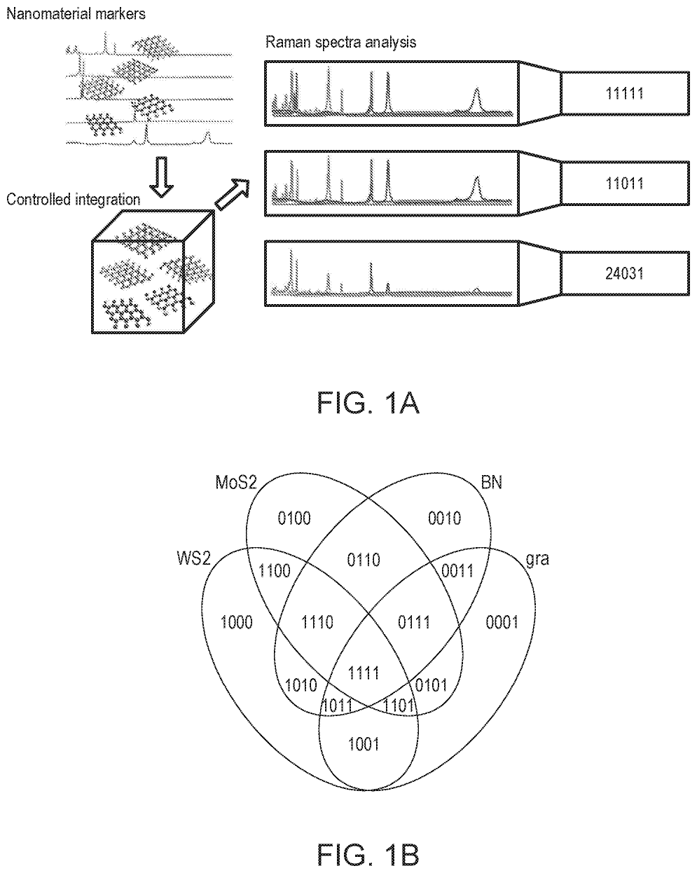

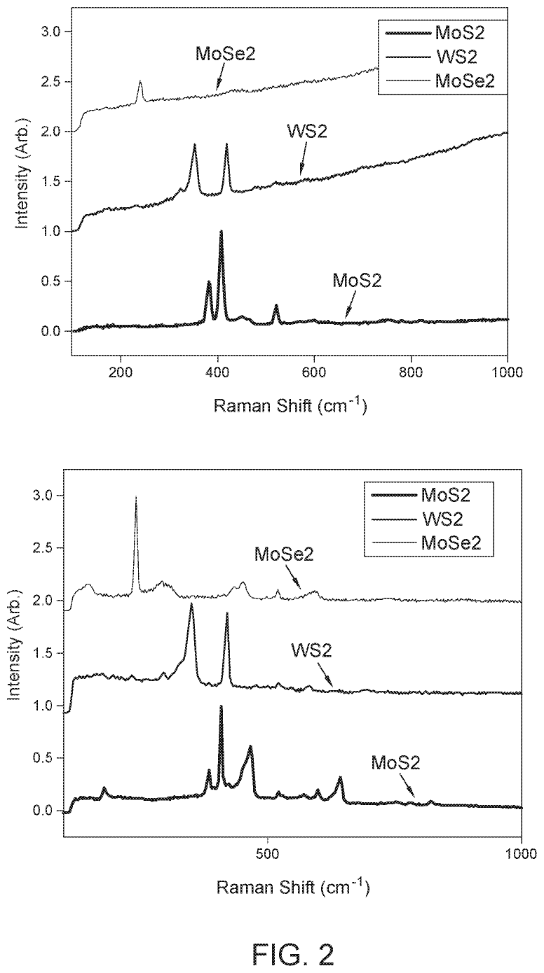

This concept is illustrated in FIG. 1A. In particular, a range of 2D materials can be integrated into a substrate or applied to the surface of a substrate. The substrate can then be analysed using Raman spectroscopy. The most intense peak in the Raman spectra or a series of peaks can be used to identify and determine the presence of a given 2D material. This results in a binary type of signature, in that each 2D material will be either present (1) or absent (0) in the Raman spectrum.

Analysis of the Raman spectra of the Raman-detectible compositions comprising two or more different Raman-active 2D materials can therefore give a binary result for the presence or absence of each 2D material, giving 2ⁿ combinations of binary codes for a library of n different 2D materials. That is, 2ⁿ distinct barcodes or labels can be formed using n 2D materials.

For example, with two 2D materials the potential binary codes are (i) 11 (both 2D materials present in the spectra), (ii) 00 (neither material present in the spectra), (iii) 01 (only the second 2D material is present in the spectra) or (iv) 10 (only the first 2D material is present in the spectra). Each of these binary codes can be considered to be a barcode or label.

Thus, by using a fairly small number of 2D materials, a large number of unique barcodes or labels can be formed. For example, the top right spectra in FIG. 1A shows a spectra where five different 2D materials are present. This can be converted into a binary barcode or label, namely 11111. In contrast, in the middle spectra in FIG. 1A one of the 2D materials is absent. This corresponds to the binary barcode or label 11011.

Due to the well-defined Raman spectra associated with each 2D material, which contain relatively few but sharp Raman features, it has also surprisingly been found that the relative concentrations of the two or more 2D materials within the Raman detectible compositions can also be determined by analysis of the Raman spectra. Depending on the complexity of the Raman spectra this can be done by direct analysis or by running peak finding/fitting algorithms and integrating peak areas. This analysis mode involves determining not only the presence (or absence) but also the relative concentration of any given 2D material, and is illustrated in the lower right graph of FIG. 1A.

Thus, the bottom right spectra shown in FIG. 1A results in a non-binary label or barcode, namely 24031. This indicates that the five 2D materials in question are present in the relative concentrations of 2:4:0:3:1.

As would be readily appreciated by the skilled person, by measuring the relative concentration of the 2D materials in the spectra, a much larger number of possible barcodes or labels can be created using a small number of 2D materials. That is, the number of unique spectra far exceeds 2ⁿ (where n is the number of different 2D materials) when the relative concentration of the 2D materials is also taken into account. From a practical point of view, it is therefore easier to utilise the Raman-detectible compositions of the present invention, as unique spectra can be created without the need to include a large number of different 2D materials in each Raman-detectible compositions.

In addition, size dependent properties of 2D materials can induce peak shifts and broadening which can be used to add unique Raman features to the spectra.

Thus, it has surprisingly been found that barcodes or labels having unique resolvable Raman spectra can be generated by varying the relative amounts of the different 2D materials as well by varying the identity of the 2D materials within the Raman-detectible compositions. The ability to not only determine whether a Raman-active 2D material is present or absent in a Raman-detectible composition of the invention but also determine the relative concentrations of each of the 2D materials allows for a large number of unique barcodes each having a characteristic Raman spectra to be produced using a relatively low number of different Raman-active 2D materials.

Ultimately, using the Raman detectible compositions described herein allows for the traceability of any substrates to which the Raman detectible compositions are applied, or any substrates into which the Raman detectible compositions are incorporated.

By way of example, a particular Raman detectible composition of the invention could be incorporated into a particular type and brand of plastic bottles. If the label was later removed, and even if the bottle was disintegrated into fragments including microparticles, analysis of any remaining fragments of the bottle would identify the unique barcode (i.e. derivable from the unique Raman spectra) resulting from the selected Raman detectible composition. This would then allow the fragment of bottle to be traced to the manufacturer.

Another potential use would be applying a particular Raman detectible composition of the invention to fibers used to form a designer garment. Raman spectroscopy could then be used to analyse the completed garment (even if no physical label was present), and the unique barcode (i.e. derivable from the unique Raman spectra) resulting from the selected Raman detectible composition would be observed. In contrast, a counterfeit garment formed from fibers where the Raman detectible composition was not applied would not show the same Raman spectra. It would therefore be possible to distinguish between the real and the counterfeit garment (even where they were visually indistinguishable) simply by using a Raman spectrometer.

Similar methods could be used to monitor the origin of electronic components. In this case, a given Raman detectible composition could be applied to an electronic component by an approved manufacturer. The detection of the unique barcode (i.e. the unique Raman spectra) corresponding to the applied Raman detectible composition would enable an end user to verify that the component in question was authentic and originated from the approved manufacturer.

The Raman detectible compositions of the invention can therefore be used to help enforcement of good corporate citizenship, improve economic efficiencies to encourage recycling, and enforce legislation on exports and controls, to highlight just a few. The potential returns for the environment as well as for potential large commercial gains are therefore extensive.

As used herein, the term barcode or label refers to the unique tag or code that is derivable from analysis of the Raman spectra of the composition. For example, with reference to FIG. 1A, the three Raman spectra shown have corresponding barcodes or labels of 11111, 11011 and 24031. As discussed above, the first two of these are binary codes, but the same spectra could be analysed to give (different) non-binary codes, e.g. as for the final spectra in FIG. 1A.

The use of the Raman detectible compositions of the invention provides a number of advantages over conventional barcodes (which are simply printed with a black/dark ink and read by making use of the different light reflective properties of the black ink and white background).

Firstly, it is noted that the Raman detectible compositions described herein can be printed in the same pattern as conventional barcodes, in which case they could be read by conventional barcode scanners, as well as Raman spectroscopy scanners. This provides a dual functionality to the barcodes. Similarly, the Raman detectible compositions may be printed in the same pattern as conventional QR codes.

In addition, as described in more detail in an Example herein, the Raman detectible compositions described herein are stable at high temperature and/or high humidity. The Raman detectible compositions described herein are therefore considered to be more robust than organic-based materials. Furthermore, organic-based materials are prone to photobleaching over time and therefore are not suitable for use in applications where the barcode may be exposed to significant amounts of UV radiation or other high-energy radiation. The Raman detectible compositions described herein do not suffer from degradation in this way (at least not to the same extent).

### Raman-Active 2D Materials

Suitable 2D materials for use in the present invention include graphene, graphene oxide, reduced graphene oxide, borophene, germanene, silicene, stanene, phosphorene, bismuthene, hexagonal boron nitride (h-BN), 2D silicates, layered double hydroxides (LDH) such as Cu(OH)₂, Ni(OH)₂, Mg(OH)₂ and Co(OH)₂, 2D perovskites, transition metal dichalcogenides (TMDs), MoCl₃, black phosphorus, Cr₂S₃, SnO, SnSe₂, Ga₂S₃, CoO, GaPO₄, InN, FeSe, indium tin oxide (ITO), GaN, GaS, Bi₂O₂Se, CuS, GaSe, GaTe, Bi₂Te₃, Bi₂Se₃, Bi₂TeS₂, MoO₂, MoO₃, BiOCl, V₂O₅, talc, InO, InSe, InS₃, GeS and GeSe.

TMDs have the formula MX₂, wherein M is a transition metal and each X is independently a chalcogen atom (S, Se or Te). For example, the transition metal M may be Fe, Mo, Nb, W, Pt, V, Re, Zr, Pd, Co, Ti, Ta or Hf, preferably Fe, Mo, W or Ti. Preferably, X is the same—i.e. the compounds have the formula MS₂, MSe₂ or MTe₂. Preferred examples of TMDs include molybdenum disulphide (MoS₂), molybdenum diselenide (MoSe₂), molybdenum ditelluride (MoTe₂), tungsten disulphide (WS₂), tungsten diselenide (WSe₂), tungsten ditelluride (WTe₂), titanium disulphide (TiS₂) and iron disulphide (FeS₂). Even more preferred examples of TMDs include MoS₂, WS₂, WSe₂ and MoSe₂. Further examples of TMDs include niobium diselenide (NbSe₂) and hafnium disulphide (HfS₂).

In an embodiment, the 2D materials may be independently selected from: graphene, graphene oxide, reduced graphene oxide, h-BN, 2D silicates, layered double hydroxides such as Cu(OH)₂, Ni(OH)₂, Mg(OH)₂ and Co(OH)₂, 2D perovskites, TMDs, GaS, Bi₂Te₃, MoO₂, MoO₃, BiOCl, V₂O₅, talc, InSe, GeS.

In another embodiment, the 2D materials may be independently selected from: graphene, borophene, germanene, silicene, stanene, phosphorene, bismuthene, hexagonal boron nitride (h-BN), 2D silicates, layered double hydroxides (LDH) such as Cu(OH)₂, Ni(OH)₂, Mg(OH)₂ and Co(OH)₂, 2D perovskites, transition metal dichalcogenides (TMDs), MoCl₃, black phosphorus, Cr₂S₃, SnO, SnSe₂, Ga₂S₃, CoO, GaPO₄, InN, FeSe, indium tin oxide (ITO), GaN, GaS, Bi₂O₂Se, CuS, GaSe, GaTe, Bi₂Te₃, Bi₂Se₃, Bi₂TeS₂, MoO₂, MoO₃, BiOCl, V₂O₅, talc, InO, InSe, InS₃, GeS and GeSe.

Preferably, the 2D materials are independently selected from: graphene, graphene oxide, reduced graphene oxide, h-BN, and TMDs. More preferably, the 2D materials are independently selected from: graphene, graphene oxide, h-BN, and TMDs. Even more preferably, the 2D materials are independently selected from: graphene, h-BN, and TMDs. The TMDs may be any of those listed above. Most preferably, the TMDs are molybdenum disulphide, tungsten disulfide, tungsten diselenide, or molybdenum diselenide. Thus, most preferably the 2D materials are independently selected from graphene, h-BN, molybdenum disulphide, tungsten disulfide, tungsten diselenide, and molybdenum diselenide.

Without wishing to be bound by theory, it is believed that 2D materials exhibit high absorbance relative to their thickness (for example, about 2.3% per monolayer in graphene and about 15% in MoS₂) meaning that they absorb an appreciable fraction of the incident light even in thin coatings or at low loadings in matrix materials. This high monolayer absorbance is coupled to the high polarisability of the crystal structures and confinement-induced increases in the phonon density of states, which results in strong Raman scattering in these materials. Moreover, without wishing to be bound by theory, it is believed that the stoichiometric and structural simplicity of the 2D materials often results in a few sharp Raman features which can appear across a wide range of measurable Raman shifts, with specific Raman shifts dictated by inter alia the atomic masses of the elements of which the materials are composed.

The Raman shifts of preferred 2D materials for use in the invention are set out in Table 1 below.

TABLE 1
Raman shifts of preferred 2D materials

| 2D-material | Raman shifts (cm⁻¹) |
|---|---|
| Graphene | 1350, 1580, 2650 |
| Hexagonal Boron nitride | 1360 |
| MoS₂ | 380, 410 |
| MoSe₂ | 167, 240 |
| WS₂ | 350, 420 |
| WTe₂ | 160, 207 |
| WSe₂ | 248, 250 |
| MoTe₂ | 238, 293 |
| GaS | 180, 290, 360 |
| TiS₂ | 150, 220, 333, 375, 475 |
| InSe | 120, 180, 210 |
| GeS | 110, 210, 240 |
| Bi₂Te₃ | 105, 140 |
| BiOCl | 150, 200 |
| MoO₂ | 200, 220, 350, 360, 460, 500, 570, 750 |
| MoO₃ | 280, 340, 675, 820, 990 |
| Cu(OH)₂ | 275, 350, 420, 450, 480, 3650 |
| Ni(OH)₂ | 310, 350, 450, 510, 3650 |
| Mg(OH)₂ | 250, 270, 3650 |
| Co(OH)₂ | 240, 340, 430, 460, 500, 3550 |
| Talc | 180, 360, 675 |
| V₂O₅ | 147 |
| FeS₂ | 345, 380 |

By mixing two or more different Raman-active 2D materials together, it has surprisingly been found that a complex superposition Raman spectrum can be produced in which characteristic Raman signals from each of the constituent 2D materials can be resolved.

Preferably, the Raman-detectible composition of the invention comprises three or more different Raman-active 2D materials. More preferably, the Raman-detectible composition comprises 4 or more, such as 5 or more, different Raman-active 2D materials. In some embodiments, the Raman-detectible composition comprises from 2-30, preferably 3-20, such as 5-10, different Raman-active 2D materials.

The weight (w/w) ratio of the amount of the first 2D material to the amount of each of the other different 2D materials in the Raman-detectible composition is preferably from 1:10 to 10:1. For example, in a composition comprising two (or more) different 2D materials, the weight ratio of the amount of the first 2D material to the amount of the second 2D material may be from 1:10 to 10:1. In a composition comprising three (or more) different 2D materials, the weight ratio of the amount of the first 2D material to the amount of each of the other 2D materials may be from 1:10 to 10:1.

The strong Raman scattering of 2D nanomaterials also allows them to be detected at low loading concentrations in the bulk or on the surface of substrates.

The 2D materials used in the invention may form layers which are one atom or formula unit thick. These layers are typically about 1 to about 5 nm thick. In the Raman-detectible compositions described herein, the 2D materials consist of particles that are no more than a few layers thick. In this context, a few layers generally means 20 or fewer, preferably 1 to about 10, such as 1 to about 5, or 1 layer of atoms or formula units. Thus, it is preferred that the particles of the 2D materials are 1 to about 20, 1 to about 10, 1 to about 5 layers of atoms or formula units thick.

The 2D materials used in the present invention may therefore be the form of particles or flakes which generally have a thickness of from about 1 to about 50 nm, more preferably about 1 to about 10 nm, most preferably about 1 to about 5 nm. As used herein, the term “particles” includes flakes. The particles generally have an aspect ratio (length to thickness) of greater than about 50. Thus, the particles of the 2D materials may have a (number) average length of about 50 nm to about 2000 nm, preferably from about 100 nm to about 1000 nm, more preferably from about 200 to about 500 nm, where the length is equivalent to the longest dimension of the flake or particle in the direction of the layer.

The particles may have an approximately round or square shape when viewed perpendicular to the 2D plane. Thus, the width of the particles may be approximately the same as the length. Alternatively, the particles of 2D material may have an approximately rectangular shape when viewed perpendicular to the 2D plane. Thus, the particles may have a (number) average width of about 20 nm to about 1000 nm, preferably from about 50 nm to about 700 nm, more preferably from about 100 to about 300 nm, where the width is equivalent to the longest dimension of the particle which is perpendicular to the length and in the direction of the layer. The aspect ratio (length to width) of the particles is preferably less than about 3.

The 2D materials may therefore be considered to be “nanomaterials”. The size (e.g. length and width) and thickness of the particles of 2D material can be measured using atomic force microscopy, transmission electron microscopy or dynamic light scattering techniques.

The surface tension of 2D materials can be estimated using known techniques, such as known from Hernandez et al., Langmuir, 2010, 26 (5), 3208-3213 and Hernandez et al., Nat. Nanotechnol, 2008, 3(9), 563-568. This technique is based on the maximum achievable concentrations of the material in dispersion. The surface tensions of various 2D materials are known in the art. For example, the surface tension of graphene is estimated to be in the range of about 41 to about 43 mN/m. The surface tensions of most 2D materials are similar. Preferably, the surface tension of the 2D materials used in the invention ranges from about 40 to about 50 mN/m.

The 2D materials for use in the invention may be produced by exfoliating a layered 3D material in a solvent to form a 2D material. 2D materials can be readily exfoliated from layered 3D materials. Suitable methods for exfoliating layered 3D materials in a solvent to form particles of 2D materials are known in the art. For example, methods for exfoliating a layered 3D material to produce particles of a 2D material may comprise applying energy, e.g. ultrasound, to a layered 3D material in a solvent. Alternatively, shear force can be applied to a layered 3D material in a solvent.

The choice of solvent will depend in part on the material being exfoliated. Suitable methods and solvents for exfoliating a layered 3D material to form a 2D material are disclosed in WO 2020/074698, WO 2019/135094, WO 2012/028724, WO 2014/001519, US 2016/0009561 and Hernandez et al., Langmuir, 2010, 26 (5), 3208-3213. The skilled person would therefore be able to select a suitable solvent for the 2D material being exfoliated.

For example, the solvent may be selected from N-methyl-2-pyrrolidone (NMP), N-cyclohexyl-2-pyrrolidone (CHP), 1,3-dimethyl-2-imidazolidinone (DMEU), N-ethyl-2-pyrrolidone (NEP), isopropanol, acetone, cyclopentanone (CPO) and cyclohexanone (CHO).

Alternatively, the solvent may comprise a mixture of water and a surfactant. Any suitable surfactant may be used, such as an ionic or a non-ionic surfactant. The surfactant is ideally water-soluble. Triton™ X-100 (polyethylene glycol tert-octylphenyl ether) is one example of a suitable non-ionic surfactant, and sodium cholate is one example of a suitable ionic surfactant. The surfactant may be present in the solvent in the amount of from about 0.01 to about 0.05 wt. %, preferably from about 0.02 to about 0.03 wt %, based on the weight of water.

Preferably, the solvent has a surface tension of about 30 to about 50 mN/m. More preferably, the solvent has a surface tension which is approximately the same as that of the 2D material. Therefore, the solvent preferably has a surface tension of about 40 to about 50 mN/m, more preferably about 40 to about 45 mN/m.

The surface tensions of most liquids are well known in the art, (see, for example, Thermophysical Properties of Chemicals and Hydrocarbons, Carl L. Yaw, William Andrew, Norwich, NY, 2008). Alternatively, the surface tension of a liquid can be readily characterised experimentally using the Wilhelmy plate method (as described, for example, in “Understanding Solvent Spreading for Langmuir Deposition of Nanomaterial Films: A Hansen Solubility Parameter Approach”, Large et. al., Langmuir, ACS, 2017, DOI: 10.1021/acs.langmuir.7b03867). Such a method can be carried out using a Nima PS4 surface pressure sensor at 25° C.

Thus, preferably the solvent is selected from N-methyl-2-pyrrolidone (NMP), N-cyclohexyl-2-pyrrolidone (CHP), cyclopentanone (CPO) and cyclohexanone (CHO). Cyclopentanone is particular preferred, especially for the exfoliation of graphene.

Alternatively, in other preferred embodiments the solvent may comprise a mixture of water and a surfactant, as set out above.

Alternatively, the 2D materials may be commercially available.

### Formulations

Formulations comprising a Raman-detectible composition of the invention may be used to deposit the Raman-detectible composition onto the surface of a substrate, or to incorporate the Raman-detectible composition into a substrate.

Coatings or films made from 2D materials alone form disordered porous networks of loosely bound materials and therefore exhibit minimal cohesion under abrasion. The formulations of the invention which may be used to deposit the Raman-detectible composition onto the surface of a substrate preferably therefore also contain a binder (e.g. a polymer) in order to confer robustness while maintaining the low scatter and flat background for successful Raman readout. Formulations with polymer binders affords additional performance functionalities that are required for robust industrial application.

The binder can act to increase the viscosity of the compositions and allow the compositions to be printed. The increased viscosity ensures that the compositions are suitable for printing and can improve the robustness of the dried films.

Thus, in one aspect the invention is directed to a formulation comprising a Raman-detectible composition of the invention and a binder.

The formulation may further comprise a thickening agent. The thickening agent may also act as a gelification agent, and may increase the viscosity of the compositions and allow the compositions to be printed. The increased viscosity ensures that the compositions are suitable for printing and can improve the robustness of the films. Suitable thickening agents include inorganic silicas and clays include bentonite, montmorillonites, laponite, nano-silica and titania.

Suitable binders include paraffin wax, cyclodextrins, natural gelling agents, and polymers. Preferably, the binder is a polymer. The polymer may be a water-soluble or water-insoluble polymer.

The paraffin wax preferably has a melting point of from about 50 to about 70° C., more preferably from about 55 to about 65° C., even more preferably from about 58 to about 62° C., and most preferably about 60° C.

Suitable natural gelling agents include xanthan gum, gelatine, glycerol, alginates and chitosan.

Suitable polymers for use as the binder include: polyvinylpyrrolidone (PVP); polyvinyl alcohol (PVOH); dextran; poly(acrylic acid sodium salt); poly(ethylene glycol); poly(methylacrylic acid sodium salt); pullulan; cellulose derivatives (e.g. carboxymethyl cellulose, methyl cellulose, hydroxyethyl cellulose and carboxyethyl cellulose, and salts thereof (such as sodium salts thereof)); cellulose esters (e.g. cellulose acetate); polyurethanes, such as thermoplastic polyurethanes; poly(methyl methacrylate); poly(methyl methacrylate-co-butyl methacrylate) [PM MA-co-BA]; polyvinyl acetate; natural rubber; synthetic poly(isoprene); thermosetting polymers, such as epoxy resins (polyepoxides); polypropylene oxide (PPO), polyaniline (PANI); and poly N-isopropylacrylamide (PNIPAAm), polyacrylate.

In some cases, suitable polymers that may be used as the binder include water soluble polymers; cellulose esters (e.g. cellulose acetate); thermoplastic polyurethanes; poly(methyl methacrylate); poly(methyl methacrylate-co-butyl methacrylate) [PMMA-co-BA]; polyvinyl acetate; natural rubber; and synthetic poly(isoprene). Some of these polymers (e.g. poly(methyl methacrylate-co-butyl methacrylate) [PMMA-co-BA], polyvinyl acetate, natural rubber and synthetic poly(isoprene)) may be provided as a latex dispersion.

The water soluble polymers may be independently selected from polyvinylpyrrolidone (PVP); polyvinyl alcohol (PVOH); dextran; poly(acrylic acid sodium salt); poly(ethylene glycol); poly(methylacrylic acid sodium salt); pullulan; water soluble cellulose derivatives (e.g. carboxymethyl cellulose); and combinations thereof. Preferably, the water soluble polymer is PVP or PVOH.

In some embodiments, the polymer is selected from polyurethanes (PU), polyethylene oxide (PEO), polypropylene oxide (PPO), polyaniline (PANI), polyvinylpyrrolidone (PVP), polyvinyl alcohol (PVA), poly N-isopropylacrylamide (PNIPAAm), polyacrylate and poly(methyl)acrylate.

Suitable water-insoluble polymers that may be used as the binder include: cellulose esters (e.g. cellulose acetate); polyurethanes (optionally thermoplastic polyurethanes); poly(methyl methacrylate); poly(methyl methacrylate-co-butyl methacrylate) [PMMA-co-BA]; polyvinyl acetate; natural rubber; synthetic poly(isoprene); and thermosetting polymers, such as epoxy resins (polyepoxides). In the formulations of the invention, water-insoluble polymers may be used in the form of a latex dispersion.

The nature of the binder or thickening agent may depend on the substrate and the intended application of the formulation of the invention. Preferably, the binder is a water-insoluble binder so that a printed formulation of the invention cannot be easily washed off the substrate with water. Examples of preferred binders include polymers selected from, natural rubber, polyurethane, polyacrylate and poly(methyl)acrylate. The polymers listed herein may be functionalised. For example, the polymers may be co-polymers containing other functional groups

For “waterproof” applications (such as when the formulation is likely to be exposed to water or high humidity), non-aqueous binders may be more preferable. Therefore, the composition may comprise a water-insoluble polymer (such as polyurethane).

The formulations may be binder only systems (i.e. containing binder(s) without a carrier or solvent) which are amenable to UV photocuring and fast setting for widespread industrial application. Water insoluble polymer binders may also be dispersed as discrete latex particles which form consolidated films upon removal of the carrier or solvent.

Preferably, the formulation comprises a total of about 0.1 wt. % to about 99.9 wt. %, more preferably about 0.1 wt. % to about 85 wt. % of 2D materials. More preferably, the formulation comprises a total of about 0.5 wt. % to about 75 wt. % of 2D materials, and even more preferably the formulation comprises a total of about 1 wt. % to about 50 wt. % 2D materials.

Preferably, the formulation comprises from about 0.1 wt % to about 99.9 wt % binder, more preferably about 15 wt. % to about 99.9 wt. % binder, more preferably from about 25 wt. % to about 99.5 wt. % binder, even more preferably from about 50 wt. % to about 99 wt. % binder.

Printed barcodes may have a total 2D material-content of up to 20% w/w, for example up to 15% w/w, for example up to 10% w/w. The total 2D material-content must be sufficient to provide a Raman signal-to-noise ratio that allows for reliable readability of the Raman scattering of the composition. Printed barcodes typically have a total 2D-material-content of greater than 0.1% w/w. These ranges apply equally when the 2D-materials are in the form of nanoplatelets.

Some embodiments provide a formulation as defined herein having a total 2D material-content of up to 20% w/w, for example up to 15% w/w, for example up to 10% w/w. The formulation typically has a total 2D-material content of greater than 0.1% w/w. These ranges apply equally when the 2D-materials are in the form of nanoplatelets.

In some cases, the total concentration of the binder or thickening agents may be in the range of 0.5% to 2% by weight of the total formulation (including the solvent), for example from 1% to 1.75% by weight of the total formulation.

The formulations may also include one or more surfactants. The surfactants are typically non-ionic surfactants. Examples of suitable non-ionic surfactants include polyethylene oxide-based surfactants (e.g. Triton X-100). However, ionic surfactants, such sulphate-based surfactants (such as sodium dodecyl sulphate) may also be used. The surfactant may be a residue carried forward from the exfoliation process that may be used to produce the 2D materials.

The formulations of the invention can be mixed with a carrier and used as a ink. The ink can then be used to coat the formulation onto a substrate. When the binder in the formulation of the invention is paraffin, the mixture of binder and the two or more different 2D materials can be directly applied onto a substrate without a carrier. Alternatively, the formulations of the invention can be directly incorporated into a substrate.

### Inks

The Raman-detectible compositions described herein may be used in the form of inks. The ink comprises a formulation of the invention and a carrier (which may also be referred to as a solvent). Thus, the ink comprises a Raman-detectible composition of the invention, a binder (e.g. a paraffin wax or a polymer, preferably a polymer) and a carrier. The carrier is a liquid carrier, and the overall ink composition is liquid.

The ink may comprise a Pickering emulsion stabilised by the two or more Raman-active 2D materials. Suitable Pickering emulsions may be prepared as described in WO 2019/135094.

The ink may applied to a substrate by any suitable method such as printing (e.g. inkjet printing, screen printing, gravure printing or flexographic printing), spray coating, dip coating, doctor blading, spin coating and/or slot die coating. Preferred application methods include inkjet printing, screen printing, gravure printing, flexographic printing and spray coating.

The nature and amount of binders or other additives present may depend on the method of applying the composition to the substrate as well as the intended end use of the article bearing the substrate.

The carrier may be aqueous or non-aqueous, and the nature of the carrier may be dependent on the intended application of the composition/barcode. For some applications, water will be a suitable carrier. Alternatively, for water-proof inks, the carrier may be a dipolar aprotic solvent. Examples of such dipolar aprotic carriers include cyclopentanone, cyclohexanone, N-methylpyrrolidone (NMP), dimethylformamide (DMF), dimethylsulphoxide (DMSO), dimethylacetamide (DMAc), sulpholane, and dihydrolevoglucosenone (cyrene).

The carrier may be water, which is particularly preferred when the binder is a water soluble polymer or when the formulation comprises a binder that may form a latex dispersion.

The carrier may also be selected from: gamma-valerolactone (GVL), N-methyl-2-pyrrolidone (NMP), N-cyclohexyl-2-pyrrolidone (CHP), 1,3-dimethyl-2-imidazolidinone (DMEU), N-ethyl-2-pyrrolidone (NEP), isopropanol, acetone, cyclopentanone (CPO) and cyclohexanone (CHO).

The ink of the invention may also comprise one or more adhesives in order to improve adhesion of the dried ink to a substrate. The nature of the adhesive may be dependent on the substrate.

The ink may also comprise one or more thickening agents in order to improve the rheological parameters of the ink and/or properties of resulting coatings or films. Suitable thickening agents for use in the inks of the invention include inorganic silicas and clays include bentonite, montmorillonites, laponite, nano-silica and titania.

The ink may also comprise a setting agent, which is a material that cures upon exposure to heat or radiation to cure and set the liquid ink compositions into a solid film. These include photocurable monomers or infra-red activated agents, e.g. epoxides (which may undergo ring opening reactions), aldehydes or acids (which may undergo esterification reactions) such as citric acid.

In an exemplary embodiment, the invention provides an ink comprising:
(a) two or more 2D materials selected from graphene, boron nitride, MoS₂ and WS₂;
(b) a polymeric binder (e.g. polyurethane or polyvinyl alcohol); and
(c) a carrier (e.g. water or cyclohexanone).

The ink may comprise about 15 or 25 wt % to about 99.9 wt % carrier. Preferably, the ink comprises about 80 to about 99.9 wt. % carrier. More preferably, the ink comprises about 90 to about 99.9 wt. % carrier, such as in the case of Pickering emulsions.

The remainder of the ink preferably comprises 2D materials and binder. Thus, the ink may comprise from about 0.1 to about 75 or 85 wt % of 2D materials and binder, preferably from about 0.1 to about 20 wt. % of 2D materials and binder, more preferably from about 0.1 to about 10 wt. % of 2D materials and binder.

The relative ratios of 2D materials to binder are the same as those discussed above in relation to the formulation. That is, the total amount of 2D materials is preferably from about 0.1 wt. % to 85 wt. % based on the total weight of the binder and 2D materials within the carrier. More preferably, the total amount of 2D materials is from about 0.5 wt. % to about 75 wt. % based on the total weight of the binder and 2D materials within the carrier, and even more preferably the total amount of 2D materials is from about 1 wt. % to about 50 wt. % based on the total weight of the binder and 2D materials within the carrier.

Similarly, preferably the binder is present in the amount of from about 15 wt. % to about 99.9 wt. %, more preferably from about 25 wt. % to about 99.5 wt. %, even more preferably from about 50 wt. % to about 99 wt. % based on the total weight of the binder and 2D materials within the carrier.

### Substrates

In one aspect, the invention is directed to a substrate comprising a Raman-detectible composition of the invention. As set out above, the Raman-detectible composition may be present in a formulation of the invention further comprising a binder.

The Raman-detectible composition of the invention may be homogeneously dispersed within the substrate, or may be applied to the surface of the substrate.

Thus, in one aspect, the invention is directed to a substrate which is at least partially coated with a Raman-detectible composition of the invention.

That is, the invention is directed to a substrate comprising a Raman-detectible composition comprising two or more different Raman-active 2D materials, wherein the Raman-detectible composition is on the surface of the substrate.

When the Raman-detectible composition is on the surface of the substrate the binder is preferably also be present. As such, the invention is also directed to a substrate which is at least partially coated with a formulation of the invention.

In contrast, when the Raman-detectible composition is homogeneously dispersed within a (non-metal) substrate, the binder is not essential. Thus, in another aspect, the invention is directed to a non-metal substrate which contains a Raman-detectible composition which comprises two or more different Raman-active 2D materials.

That is, the invention is directed to a substrate comprising a Raman-detectible composition comprising two or more different Raman-active 2D materials, wherein the Raman-detectible composition is homogeneously dispersed within the substrate, and wherein the substrate is not a metal.

A further way of implementing the invention may be to apply a Raman-detectible composition of the invention to the surface of a substrate and then apply a coating of protective material over the Raman-detectible composition to keep the Raman-detectible composition in place. The protective material may be, for example, a lacquer, a polymer, or a curable resin such as silicones or acrylics. The protective material is optionally transparent. The protective material preferably does not interfere with the Raman spectrum of the Raman-detectible composition, i.e. the protective coating does not give rise to Raman peaks which overlap with those of the Raman-detectible composition. This type of application method is particularly useful where no binder is present. The Raman-detectible composition may be applied in the form of a formulation or ink of the invention. Alternatively, a dispersion of the two or more different 2D materials in a suitable carrier may be applied to the surface and the carrier may then be removed, e.g. by evaporation.

Thus, in another aspect, the invention provides a substrate comprising a Raman-detectible composition of the invention (optionally in the form of a formulation of the invention) on the surface of the substrate and an overcoat of protective material (e.g. a lacquer, a polymer, or a curable resin such as silicones or acrylics) disposed over the Raman-detectible composition. The overcoat of protective material at least partially covers the Raman-detectible composition to protect it against abrasion. With this arrangement binder may not be necessary to prevent removal of the Raman-detectible composition from the surface of the substrate.

### Coating a Substrate

In one aspect, the invention provides a method for tagging a substrate with a Raman-detectible composition comprising two or more different Raman-active 2D materials, the method comprising applying the Raman-detectible composition to the surface of the substrate.

To apply the Raman-detectible composition to the surface of the substrate, an ink of the invention may be applied and allowed to dry. The carrier will then evaporate, leaving just the 2D materials and the optional binder (i.e. the formulation of the invention). Thus, the Raman-detectible composition of the invention is applied to at least part of the surface of a substrate. That is, the substrate is at least partially coated with a formulation of the invention.

Thus, the method set out above comprises applying the formulation of the invention to the surface of the substrate. That is, the method comprises applying a formulation comprising the Raman-detectible composition and a binder to the surface of the substrate.

The coating that is formed after the carrier has evaporated can be thought of as a thin layer of binder, with the Raman-detectible composition (i.e. the two or more 2D materials) preferably incorporated within a binder. That is, the coating corresponds to the formulation of the invention. This coating can also be described as a film.

Put another way, by this process the substrate is surface-tagged with the Raman-detectible composition of the invention.

When the binder in the formulation of the invention is paraffin, the mixture of binder and the two or more different 2D materials can be applied directly onto a substrate without a carrier.

The substrate surface may be entirely or partially coated with the formulation. Thus, the formulation (and therefore the Raman-detectible composition) may entirely or just partially cover the surface of the substrate. Where the surface is only partially coated with the formulation, it may be desirable to also include a visual indication of the area or region which has been coated, so that Raman spectroscopy can be performed on the correct part of the surface of the substrate. Spatially-resolved arrays of the formulation containing the Raman-detectible composition may be applied to the substrate surface to add additional complexity to the barcodes.

The invention therefore provides a substrate which is at least partially coated with a formulation of the invention.

Preferably, the formulation forms a layer or film on the substrate having a thickness of from about 50 nm to about 20 μm, more preferably from about 100 nm to about 10 μm, even more preferably from about 500 nm to about 5 μm.

The invention also provides a method for tagging a substrate with a Raman-detectible composition, the method comprising applying the ink of the invention to at least part of the surface of the substrate and allowing the ink to dry.

The invention also provides the use of a Raman-detectible composition or formulation of the invention to tag the surface of a substrate. By this, it is meant that the surface of the substrate is tagged or labelled with the barcode or label corresponding to the given Raman-detectible composition which is applied. In this regard, by carrying out Raman spectroscopy of the coated surface the unique Raman spectrum of the applied Raman-detectible composition will be generated. From this spectrum, the unique barcode corresponding to the applied Raman-detectible composition can be decoded.

A particular advantage of the present invention is that a wide range of substrates can be used. In fact, when the Raman-detectible composition is applied to the surface of the substrate, any substrate may be used. For example, suitable substrates which can be surface-tagged with the Raman-detectible composition of the invention include: metals; natural or synthetic fibres, preferably cotton or nylon fibres, more preferably cotton fibers; thermoplastic and thermosetting polymers; ceramics; electronic circuit components, such as integrated circuit chips; and currency, such as polymeric or paper banknotes.

Suitable thermoplastic polymers include PMMA, acrylonitrile butadiene styrene, nylons, polylactic acid, polybenzimidazole, polycarbonates, polyether sulfones, polyoxymethylene, polyaryletherketones, polyetherimide, polyethylene, polyphenylene oxide, polyphenylene sulfide, polypropylene, polystyrene, polyvinyl chloride, polyvinylidene fluoride, polytetrafluoroethylene and polyethylene terephthalate (PET). Preferably, the thermoplastic polymer is PET.

Preferably, the substrate is a natural or synthetic fibre, more preferably a cotton or nylon fibre, even more preferably a cotton fiber.

In another aspect, the present invention provides a method of tagging a substrate, the method comprising applying an ink of the invention to the surface of a substrate, and subsequently allowing the ink to dry.

### Incorporation into a Substrate

The Raman-detectible compositions described herein may also be incorporated homogeneously throughout the bulk of substrate. This allows their unique Raman signature to be detected in fragments of articles made from the material.

Small articles for which surface application of the formulations comprising the Raman-detectible composition can be impracticable can also be made from materials containing such a dispersion of the Raman-detectible composition, thereby allowing these articles to be traced.

Homogeneously incorporating the Raman-detectible composition of the invention throughout the bulk of materials also means that the identifier cannot be obscured, tampered with or removed.

When the Raman-detectible composition of the invention is incorporated into the bulk of a substrate, the substrate cannot be metal.

Thus, in one aspect the invention is directed to a method for tagging a substrate with a Raman-detectible composition comprising two or more different Raman-active 2D materials, the method comprising dispersing the Raman-detectible composition within the substrate, wherein the substrate is not a metal.

In another aspect the invention is directed to a non-metal substrate which contains a Raman-detectible composition which comprises two or more different Raman-active 2D materials. That is, the invention provides a non-metal substrate wherein the Raman-detectible composition of the invention is homogeneously dispersed within the substrate. In the context of this invention, this means that the two or more different Raman-active 2D materials are homogeneously dispersed throughout the bulk of the substrate.

Suitable substrates are the same as the substrates listed above which can be surface-tagged with the Raman-detectible composition of the invention, except that the substrate cannot be a metal.

Particularly preferred substrates for this aspect of the invention are thermoplastic polymers. Suitable thermoplastic polymers include PMMA, acrylonitrile butadiene styrene, nylons, polylactic acid, polybenzimidazole, polycarbonates, polyether sulfones, polyoxymethylene, polyaryletherketones, polyetherimide, polyethylene, polyphenylene oxide, polyphenylene sulfide, polypropylene, polystyrene, polyvinyl chloride, polyvinylidene fluoride, polytetrafluoroethylene and polyethylene terephthalate (PET). Preferably, the thermoplastic polymer is PET.

To incorporate the Raman-detectible compositions described herein into a substrate, the substrate may simply be mixed with the Raman-detectible composition. When the substrate is a polymer, the polymer can be mixed with the Raman-detectible composition and then extruded. It is preferred that after the Raman-detectible composition is mixed with the substrate, the substrate is not exposed to temperatures of more than about 400° C. during subsequent processing (e.g. during extrusion).

In some embodiments, a masterbatch composition comprising two or more different Raman-active 2D materials and binder (preferably a polymer binder) may be prepared and the masterbatch may then be incorporated into the substrate. This is particularly preferable when the substrate is a polymer. The discussion above on suitable binders also applies to the binders for use in the masterbatch composition.

The masterbatch composition may be formulated by combining two or more different 2D materials, binder (preferably a polymer binder) and solvent and then removing solvent. Hansen solubility parameters of solvents, binder polymers and 2D materials can be used to identify suitable solvents for the binder polymer and 2D materials. Hansen solubility parameters are well-known for a range of polymers and solvents.

When the substrate and binder are polymers, in some embodiments the polymer binder in the masterbatch formulation and the substrate material may be the same polymer. In other cases, the polymer binder may be different to the polymer from which the substrate is made.

For example, PMMA binder may be used in the masterbatch to aid dispersion of the different 2D materials in some substrates.

When incorporated into the substrate, the Raman-detectible composition of the invention is preferably present such that the total amount of 2D materials is less than or equal to about 0.5 wt. %, based on the total weight of the substrate. More preferably, the Raman-detectible composition of the invention is present such that the total amount of 2D materials is less than or equal to about 0.1 wt. %, based on the total weight of the substrate. The Raman-detectible composition is suitably present in the amount such that the total amount of 2D materials is from about 0.001 to about 0.5 wt. %, based on the total weight of the substrate, preferably from about 0.005 to 0.1 wt. %.

When greater amounts of 2D material are present, the Raman spectra are easier to analyse.

The invention also provides the use of a Raman-detectible composition comprising two or more different Raman-active 2D materials to tag a substrate.

The two or more Raman-active 2D materials can be pre-mixed and this pre-mix can be mixed into the bulk of a substrate or applied to the surface of the substrate. For example, the two or more Raman-active 2D materials can be pre-mixed in a masterbatch composition further comprising a polymer binder as described above. Alternatively, the two or more Raman-active materials can be separately mixed into the bulk of the substrate or separately applied to the surface of the substrate.

In Raman-detectible composition of the invention (e.g. as defined in claim 1), the formulations of the invention (e.g. as defined in claim 3), substrates of the invention (e.g. as defined in claim 4), uses of the invention (e.g. as defined in claim 5), the methods for tagging a substrate of the invention (e.g. as defined in claim 6) and the methods of the invention for analysing a substrate or formulation for the presence of the Raman-detectible composition (e.g. as defined in claim 7) the Raman-detectible composition may comprise pre-defined relative amounts of the same two or more different Raman-active 2D materials corresponding to the relative amounts used in a reference composition. In this way, the presence of the Raman detectible composition applied to the substrate can be confirmed by comparing its Raman spectrum to that of the reference composition.

Also provided by the present invention are methods of storing a code within a material, the method comprising adding two or more different 2D materials to the material in pre-defined amounts.

### Measuring and Analysing the Raman Spectra

In one aspect, the invention is directed to a method for analysing a substrate or formulation for the presence of a Raman-detectible composition of the invention, the method comprising:

(i) subjecting the substrate or formulation to Raman spectroscopy, and

(ii) analysing the Raman spectrum for the presence of a Raman signal that is characteristic of the Raman-detectible composition.

Preferably, the substrate or formulation contains a Raman-detectible composition of the invention, i.e. a composition comprising two or more different Raman-active 2D materials as defined herein.

A Raman spectrum of the substrate or formulation is therefore obtained in step (i). Step (ii) may comprise comparing the Raman spectrum obtained in step (i) to that of a reference composition, where the reference composition is the same as the Raman-detectible composition which is being tested for. For example, the reference composition may contain the same relative amounts of the same two or more different Raman-active 2D materials as is present in the Raman-detectible composition which is being tested for.

By way of example, an article to be tagged is identified. A specific Raman-detectible composition is then added to, or printed onto or, incorporated into, or otherwise associated with the article. This association, linking the specific spectrum or code of the Raman-detectible composition to the article, and being an indication of authenticity of the article, is recorded, e.g. in a table or database. As a result the article has been tagged and that tag recorded. At a later time, when it is desired to verify the authenticity of the article, the tag is read by subjecting the article or tag to Raman spectroscopy, and the spectrum or code obtained is checked with the record: if the spectrum or code is accepted as being the same then the authenticity of the article can be verified.

Any type of Raman spectroscopy may be used. However, the use of 2D nanomaterials means that the Raman signature of the Raman-detectible compositions of the invention can be detected and read without signal enhancement, such as by adsorbing Raman-active molecules onto metal nanoparticle surfaces as employed in Surface-Enhanced Raman Spectroscopy (SERS), for example surface enhanced resonance Raman scattering (SERRS). Thus, in some embodiments, the Raman spectroscopy is not surface enhanced Raman spectroscopy (such as SERRS).

The optimum choice of laser wavelength can depend on the identity of the 2D materials in the composition to be detected. For example, without wishing to be bound by theory, the absorbance of the 2D materials at the candidate wavelength and resonance effects when photon energy is close to any material bandgap energy can lead to enhanced intensity and extra peaks in Raman spectra. The inventors have found that a wavelength of 785 nm (which is above the bandgap energy for most semiconductors) provides comparable intensities and minimal background scattering. Thus, the laser wavelength may preferably be about 785 nm.

Certain substrates or binders onto or into which the Raman-detectible compositions of this invention may be applied or incorporated may themselves be Raman-active. The contribution of the substrate or binder to the Raman spectra can be excluded by measuring the Raman spectrum of the substrate and/or the binder without the Raman-detectible compositions.

The presence or absence of a 2D material in the Raman-detectible composition of the invention can be confirmed by checking whether the Raman-detectible composition's Raman spectrum includes the dominant peak or peak patterns from the Raman spectrum of a candidate 2D material. The dominant peak or peak patterns for each 2D material can be identified from reference spectra. If a reference spectrum is not available for a particular 2D material, the skilled person would be able to measure one. The Raman shifts of the dominant peaks for a number of 2D materials are set out in the Table 1. Modes for heavy element crystals may be present at Raman shifts down to around 100 cm⁻¹.

Calibration curves (for example to enable the different strengths of Raman scattering in different 2D materials to be accounted for when determining the relative amounts of the 2D materials in the Raman-detectible compositions) can be produced by measuring Raman spectra for dispersions of exfoliated 2D materials at different controlled concentrations.

The Lorenzian/Gaussian peaks in the Raman spectra of the Raman-detectible compositions can be matched to the Raman peaks of the constituent 2D materials and fitted, for example using suitable software, to determine which 2D materials are present in the Raman-detectible compositions and the relative amounts of each of the 2D materials.

The Raman spectra of the Raman-detectible compositions can also be assigned by comparison with reference Raman spectra produced from combinations of different 2D materials that have been mixed in controlled mixing ratios.

As set out above, the invention also provides a method of generating a code based on the 2D material content of a substrate, the method comprising:

a) measuring and obtaining the Raman spectrum of the substrate, wherein the substrate comprises two or more different Raman-active 2D materials;

b) comparing the obtained Raman spectrum with reference data for each of the two or more different 2D materials in order to determine the presence, and optionally the quantities, of the two or more different 2D materials;

c) generating a code based on the presence, and optionally the quantities, of the two or more different 2D materials.

In this way, a code is read from the substrate. Where the substrate is part of or attached to or incorporated into an article, the code is read from the article.

Based on this code, the authenticity of an article bearing/containing the 2D materials can therefore be verified.

The substrate may be a substrate to which a Raman detectible composition as described herein has been applied, or a substrate containing a Raman detectible composition as described herein.

As set out above, the Raman spectrum can be measured without signal enhancement, i.e. without using SERS or SERRS.

The invention also provides a method of verifying the authenticity of an article, the method comprising:

a) generating a code according to a method described herein;

b) comparing the generated code with a known code to determine the authenticity of the article.

The invention also provides an apparatus for verifying the authenticity of articles, the apparatus comprising:

(a) a Raman spectrometer, the spectrometer comprising a laser light source and a detector;

(b) an electronic data store for storing known Raman reference data of two or more different Raman-active 2D materials;

(c) an electronic data processor for comparing the Raman spectrum obtained by the spectrometer and the Raman spectra in the electronic data store; and

(d) an output device for indicating to the user either:
i) a code derived from the obtained Raman spectrum; or
ii) an indication of the authenticity of the article.

The methods described above can be carried out using conventional Raman spectrometer devices, which are well-known in the art. Such spectrometers typically comprise: a laser light source; a filter which is able to collect Raman scattered light and filter out Raleigh and anti-Stokes light; and a detector (which may also include a diffractor) for measuring the wavelength of the Raman scattered light from the sample.

The methods described above may comprise comparing the measured spectrum with known Raman spectra of 2D materials which may be present within the material (i.e. reference data). When the method is an entirely computer implemented method, the reference data may be stored on an electronic storage device (e.g. device memory) of the device/apparatus carrying out the method. The electronic storage device can receive the reference data either through a wired connection or wireless connection (e.g. a wireless transmitter/receiver within the device).

The methods described above may comprise generating a code based on the comparison of the measured spectrum and the reference data. The concept of quantised encoding relies on the concept that presence and discrete relative concentrations of each 2D material/nanoplatelet within a sample can be determined.

As shown in FIG. 1B, by simply detecting the presence or absence of four different 2D materials, 15 samples each encoding a unique 4-digit binary number can be obtained (wherein each digit corresponds to a different nanomaterial and the 0 or 1 figure indicates the absence or presence of the nanomaterial in the sample). The detection of the presence or absence of a 2D material/nanoplatelet can be carried out by detecting a Raman shift at a wavelength unique to that 2D material. The term binary, as used herein, refers to a string of digits, wherein each digit is selected from 0 or 1.

Accordingly, the code referred to herein may be a multi-digit binary code, wherein each digit of the code corresponds to the presence or absence of a type of 2D material/nanoplatelet present within the material.

The intensity or peak area will vary according to the amount of substance added to the sample. This makes available the ability to introduce a base number code system which gives more combinations than would be expected if simply determining its presence or not (binary—or base 2). In this case, not only does the presence of the 2D-material (i.e. the presence of a Raman shift at a unique wavelength) contribute to the code, but also the relative peak area/intensity—which corresponds to the quantity of the 2D-material present—contributes to the code generated. The term non-binary, as used herein, refers to a string of digits, wherein each digit is selected from three or more numbers (i.e. is not limited to 0 or 1).

Accordingly, the code referred to herein may be a multi-digit numerical code wherein each digit of the code corresponds to the quantity of a type of 2D material present within the material.

The invention therefore makes possible, with a relatively simple number of different compounds, the encoding of a high level of combinations. This must also allow for relative degeneracy within some combinations i.e. 1:1 will read the same as 2:2. There are also combinations which have only one component present which read similar, i.e. 1:0 and 2:0. Even with these considerations, with base systems of 3 and above it is possible to expand the combinations quickly.

The reference data (referred to in the methods described above) comprises characteristic Raman scattering wavelengths (or “Raman Shifts”) for each of the types of 2D materials present in the material/composition. For non-binary codes, the reference data may also include the Raman intensity at a given wavelength (for each 2D material in a specific concentration). This enables a relative concentration of each 2D material to be calculated.

Once a code has been read, e.g. generated as described above, the code can be compared with a known code (which would be expected to be obtained for an authentic article) in order to verify the authenticity of an article. Accordingly, the invention also provides a method of verifying the authenticity of an article, the method comprising:

a) generating a code according to a method of the invention; and

b) comparing the generated code with a known code to determine the authenticity of the article.

As discussed above, the methods may be conducted either partly or entirely by a computer. Accordingly, the methods described herein may be computer-implemented methods. Hence the code is read from an article and checked with a record of codes that indicate an authentic article.

### Apparatus for Verifying the Authenticity of Articles

The invention also provides an apparatus for verifying the authenticity of articles, the apparatus comprising:

(a) a Raman spectrometer, the spectrometer comprising a laser light source and a detector;

(b) an electronic data store for storing known Raman reference data of two or more different 2D materials;

(c) an electronic data processor for comparing the Raman spectrum obtained by the spectrometer and the Raman spectra in the electronic data store; and

(d) an output device for indicating to the user either:
i) a code derived from the obtained Raman spectrum; or
ii) an indication of the authenticity of the article.

The apparatus may contain the features described above in relation to methods of generating a code.

The output device may be a visual and/or audible output device and may be selected from light sources (e.g. LEDs), visual displays and speakers or other sound-producing devices. The output device may provide a different output depending on whether the obtained code matches the expected code (and thereby indicating the authenticity of the article) or whether it does not. Alternatively, the output device can display the obtained code for the user to then manual confirm whether this corresponds to an expected code for an authentic article.

The apparatus may further comprise a data sender/receiver for communicating with a remote database for accessing and retrieving the reference data and/or information to allow the apparatus to indicate the authenticity of the article.

All documents referred to herein are incorporated by reference.

### EXAMPLES

### Materials and Methods

MoS₂, WS₂, MoSe₂ and Triton X-100 were supplied by Sigma Aldrich. Dispersions were prepared by adding 45 g/L of material to be exfoliated to a solution of 3 g/L Triton X-100 in water. The total volume to be processed was 80 mL. The mixture was agitated using an ultrasonic probe (Vibracell 750 W) at 60% amplitude for 3 hours. Large aggregates were removed by ultracentrifugation at 200 g for 20 minutes. The top 70% of dispersion was decanted for further use.

### Example 1—Spraying 2D Nanomaterials onto Substrates

2D material dispersions were diluted in water PVP solutions such that the final concentration was 0.1 g/L 2D material and 10 g/L PVP. The mixture was sprayed onto cotton fibres at a distance of 5 cm using a commercial airbrush at a pressure of 3 bar (300 kPa). The duration of spray determined the loading of 2D materials.

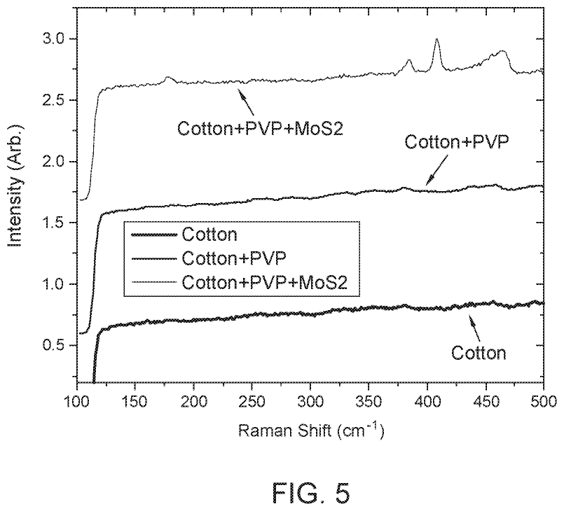

The coated substrates were analysed using Raman spectroscopy according to the procedure set out below in Example 4, and the spectra are shown in FIG. 5.

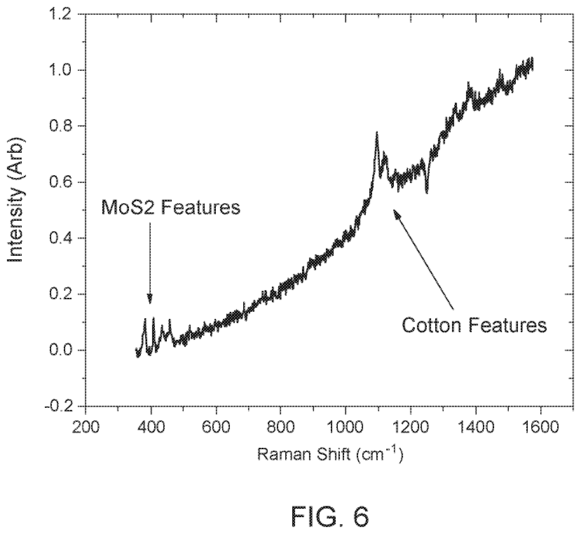

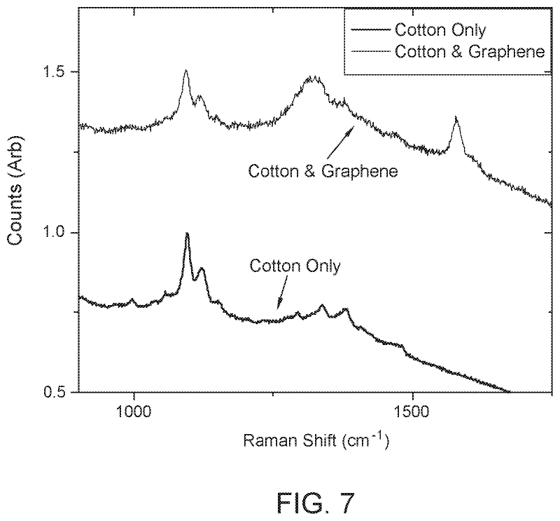

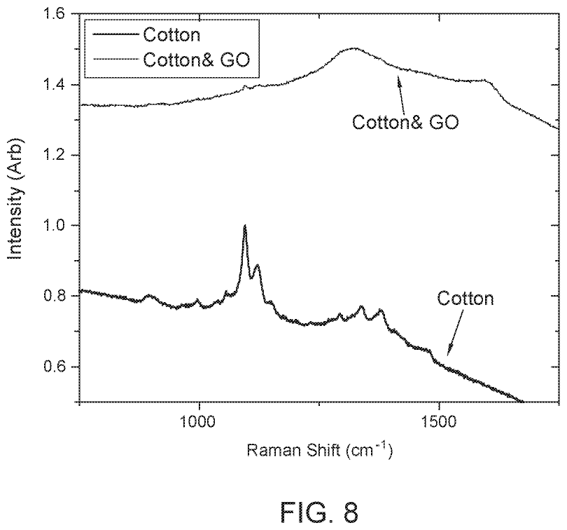

Further cotton fibers were also coated with MoS₂, Graphene and Graphene oxide by spraying a composition containing one of these 2D materials onto the fibers using an aerosol brush spray brush at a distance of approximately 10 cm with a driving pressure of 3 bar (300 kPa). The coated substrates were analysed using Raman spectroscopy according to the procedure set out in Example 4 and the spectra are shown in FIGS. 6-8.

### Example 2—Paraffin Deposition

2D material was removed from solvent via freeze drying. The resulting powder was added to a paraffin melt (70° C.) under shearing using a Silverston L5 series mixer at 5 krpm for 10 minutes. Samples were cooled and cast in moulds at room temperature to form a formulation comprising 2D materials and paraffin wax. 2D material was administered to cotton fibres by rubbing the fibres with the formulation comprising 2D material and paraffin wax.

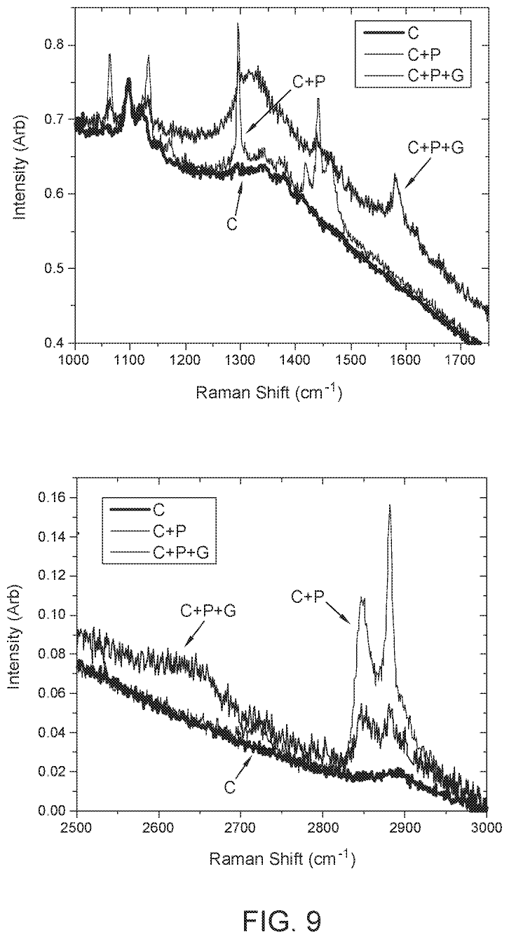

The coated substrates were analysed using Raman spectroscopy according to the procedure set out below in Example 4, and a spectrum is shown in FIG. 9.

### Example 3—Drop-Casting Formulations

2D material dispersions were diluted in water PVP solutions such that the final concentration was 0.1 g/L nanomaterial 10 g/L PVP. The mixture was then drop-cast onto the surface of Si wafer substrates.

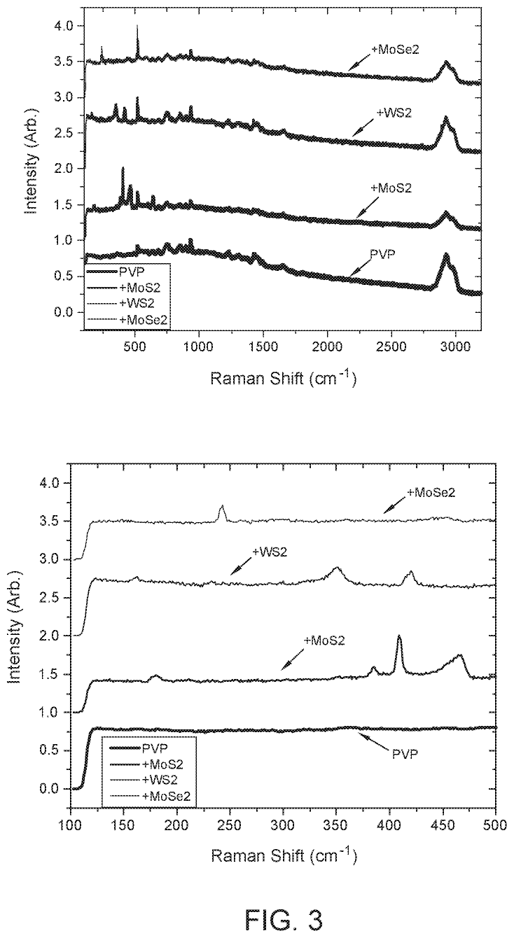

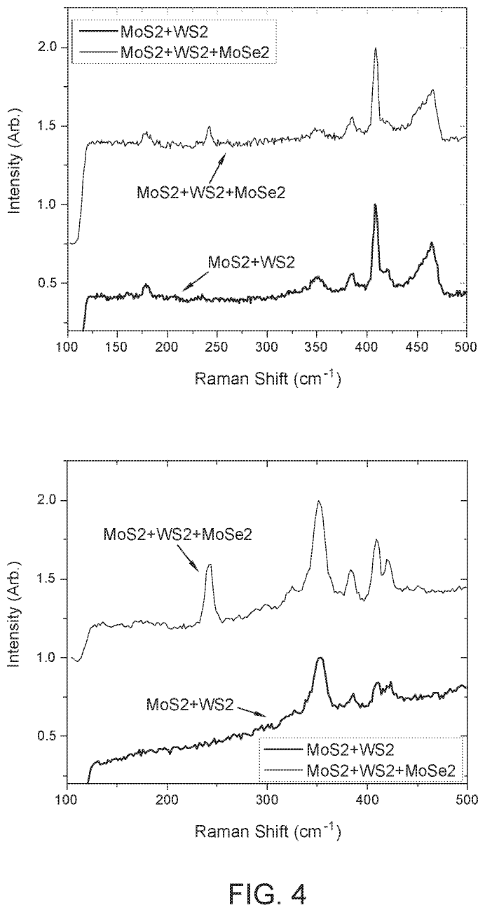

The coated substrates were analysed using Raman spectroscopy according to the procedure set out below in Example 4, and the spectra are shown in FIGS. 3 and 4.

### Example 4—Raman Measurements

The spectra were acquired with a variety of lasers (532 nm, 660 nm, 785 nm) with powers in the range of 50-100 mW. 20 acquisitions were taken using 1% of the laser power in a 20× objective lens. Each acquisition was 10 s long.

### Example 5—Preparation of Binary Compositions

Dispersions of MoS₂ and WS₂ 2D materials were prepared by subjecting 3D layered MoS₂ and WS₂ material to ultrasonication in an aqueous solution of Triton X-100.

Alternatively, 2D material can be produced using a high-pressure homogenisation apparatus (as described in WO 2020/074698).

The dispersion of MoS₂ and WS₂ was added to an aqueous solution of PVA and sprayed onto a polymeric substrate.

### Example 6—Testing of Binary Compositions

MoS₂ and WS₂ dispersions (prepared and blended as described in Example 5) were deposited as binder-free films and characterised by Raman spectroscopy (532 nm laser excitation, 5× magnification objective, 10 s acquisition time). The Raman spectra exhibit characteristic peaks for MoS₂ (E and A modes at Raman shifts of ˜380 and ˜410 cm⁻¹ respectively) and WS₂ (E and A at ˜350 and ˜420 cm⁻¹ respectively) in the individual “10” and “01” samples.

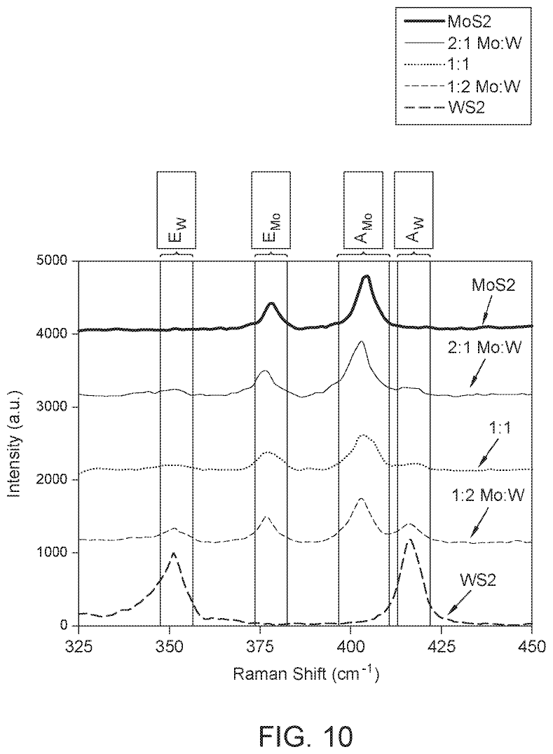

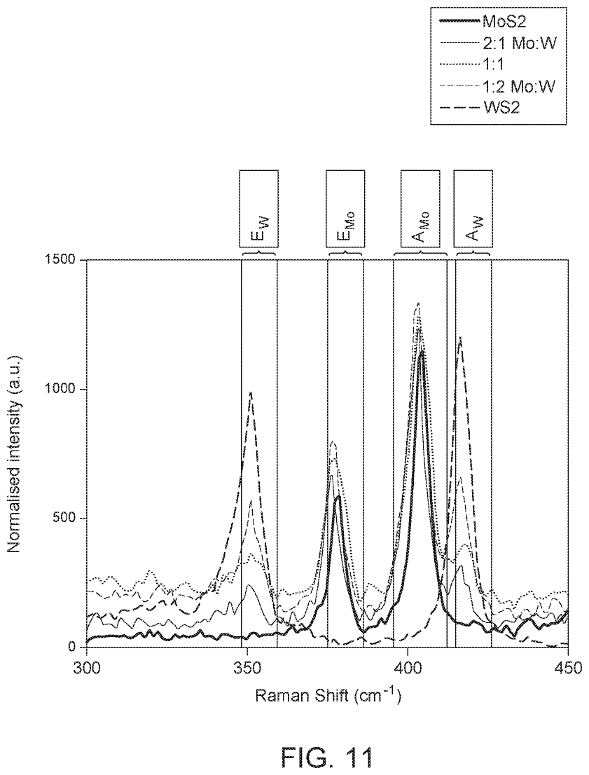

By plotting peak ratios versus mass fraction (both as MoS₂/WS₂ and WS₂/MoS₂) calibration plots for Raman peak ratio as a function of the barcode composition were obtained (see FIGS. 10 and 11). These ratios all show linear scaling with mass fraction and shows that peak ratios and therefore barcode digits can be controlled in a calibratable manner with composition and also allow for determination of mass composition which should yield comparable Raman intensities (i.e. 10-30 wt. % MoS₂, depending on the specific Raman peak, corresponding to at least two times increase in WS₂ mass loading). These calibrations are defined by the gradients of these plots and the scatter around the fit line.

These results therefore show that it is possible to use dispersions of few-layer nanosheets with extinction-measured concentrations and blend to form coatings with controllable Raman spectra.

### Example 7—Preparation and Testinq of Quaternary Compositions

Dispersions of MoS₂, WS₂, boron nitride (BN) and graphene 2D materials were prepared by subjecting the corresponding 3D layered materials to ultrasonication in an aqueous solution of Triton X-100. Alternatively, 2D materials can be produced using a high-pressure homogenisation apparatus (as described in WO 2020/074698).

The dispersion of MoS₂, WS₂, BN and graphene were added to a solution of polyurethane in cyclopentanone and sprayed onto a polymeric substrate.

Initial efforts to extend binary barcoding beyond MoS₂/WS₂ coatings characterisation above dispersions of few-layer MoS₂ and WS₂ along with BN and graphene in cycloketone solvents were used to form composites in thermoplastic polyurethanes with combinations of these four materials.

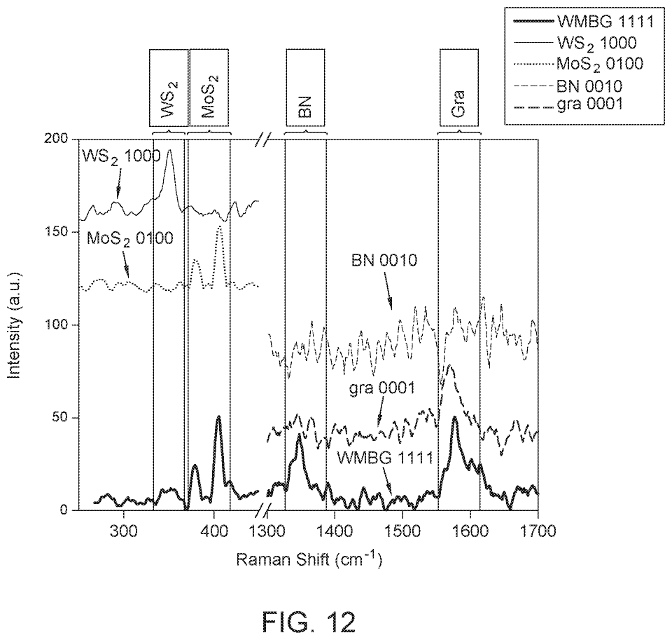

As shown in FIG. 12, the Raman spectra of these materials define the order of the WS₂-MoS₂-BN-graphene nomenclature for these barcodes. These Raman measurements were performed under 532 nm laser excitation with 5% laser power, 20× magnification objective and 0.1 s acquisition time.

The Raman scattering intensity differences between different nanoplatelets when present at the same loading, means that for some low-intensity materials the signal-to-noise ratio is too low for peak identification. Therefore, the mass fraction of low-intensity materials is increased to give comparable intensity peaks with signal-to-noise ratios which allow for clear peak identification. Using WS₂:MoS₂:BN:Graphene in an approximate ratio of 3:1:10:10 was found to give similar intensities for all four nanoplatelets and maximum correct peak identification.

### Example 8—Stability Testing

### A. Temperature Testing for Chemical (Raman) Stability

Samples of barcodes prepared according to Examples 5 or 6 were heated to the 125° C. They were subject to Raman measurement before and after heating and there were no discernible changes to the chemical stability based on the Raman spectra.

This is consistent with observations on heating of the nanoplatelets in isolation, where graphene and BN are relatively inert to much higher temperatures and the onset of MoS₂ and WS₂ oxidation is around 200° C.

### B. Temperature Testing for Mechanical Robustness

Samples were also subjected to the Scotch tape test to ascertain adhesion as a proxy for mechanical robustness before and after heating.

These samples were found to be very robust to this adhesive test and even other physical abrasions.

### C. Combined Temperature/Humidity Testing

Samples were heated to elevated temperature in a convection oven with a reservoir of water to increase the relative humidity (RH). This was measured accurately to increase RH to around 50% from 20%. Samples heated in the increased humidity environment showed no change in their Raman spectra or robustness compared to the starting samples or the heated samples, indicating that the final formation exhibits good environmental robustness under these conditions.

The invention also provides the following Embodiments:

A1. A formulation comprising a Raman-detectible composition and a binder; wherein the Raman-detectible composition comprises two or more different Raman-active 2D materials.

A2. A substrate comprising a Raman-detectible composition comprising two or more different Raman-active 2D materials, wherein:
(i) the Raman-detectible composition is homogeneously dispersed within the substrate, and wherein the substrate is not a metal; or
(ii) the Raman-detectible composition is on the surface of the substrate.

A3. Use of a Raman-detectible composition comprising two or more different Raman-active 2D materials to tag a substrate.

A4. A method for tagging a substrate with a Raman-detectible composition comprising two or more different Raman-active 2D materials, the method comprising:
(i) dispersing the Raman-detectible composition within the substrate, wherein the substrate is not a metal; or
(ii) applying the Raman-detectible composition to the surface of the substrate.

A5. A method for analysing a substrate or formulation for the presence of a Raman-detectible composition comprising two or more different Raman-active 2D materials, the method comprising:
(i) subjecting the substrate or formulation to Raman spectroscopy, and
(ii) analysing the Raman spectrum for the presence of a Raman signal that is characteristic of the Raman-detectible composition.

The substrate or formulation preferably comprises the Raman-detectible composition.

A6. A Raman-detectible composition comprising two or more different Raman-active 2D materials.

A7. The formulation, substrate, use, method or Raman-detectible composition according to any preceding Embodiment, wherein the Raman-detectible composition comprises three or more, preferably four or more, more preferably five or more, different Raman-active 2D materials.

A8. The formulation, substrate, use, method or Raman-detectible composition according to any preceding Embodiment, wherein the 2D materials are independently selected from: graphene, graphene oxide, reduced graphene oxide, borophene, germanene, silicene, stanene, phosphorene, bismuthene, hexagonal boron nitride (h-BN), 2D silicates, layered double hydroxides (LDH) such as Cu(OH)₂, Ni(OH)₂, Mg(OH)₂ and Co(OH)₂, 2D perovskites, transition metal dichalcogenides (TMDs), MoCl₃, black phosphorus, Cr₂S₃, SnO, SnSe₂, Ga₂S₃, CoO, GaPO₄, InN, FeSe, indium tin oxide (ITO), GaN, GaS, Bi₂O₂Se, CuS, GaSe, GaTe, Bi₂Te₃, Bi₂Se₃, Bi₂TeS₂, MoO₂, MoO₃, BiOCl, V₂O₅, talc, InO, InSe, InS₃, GeS and GeSe.

A9. The formulation, substrate, use, method or Raman-detectible composition according to Embodiment A8, wherein the 2D materials are independently selected from: graphene, graphene oxide, reduced graphene oxide, h-BN, 2D silicates, layered double hydroxides such as Cu(OH)₂, Ni(OH)₂, Mg(OH)₂ and Co(OH)₂, 2D perovskites, TMDs, GaS, Bi₂Te₃, MoO₂, MoO₃, BiOCl, V₂O₅, talc, InSe, GeS.

A10. The formulation, substrate, use, method or Raman-detectible composition according to Embodiment A9, wherein the 2D materials are independently selected from: graphene, graphene oxide, reduced graphene oxide, h-BN, and TMDs, preferably wherein the 2D materials are independently selected from: graphene, h-BN, and TMDs.

A11. The formulation, substrate use, method or Raman-detectible composition according to any one of Embodiments A8-A10, wherein the transition metal dichalcogenides are independently selected from: MoS₂, MoSe₂, MoTe₂, WS₂, WSe₂, WTe₂, TiS₂ and FeS₂.

A12. The formulation, substrate, use, method or Raman-detectible composition according to any preceding Embodiment, wherein the 2D materials are independently selected from: graphene, graphene oxide, h-BN, MoS₂, WS₂ and MoSe₂, preferably wherein the 2D materials are independently selected from: graphene, h-BN, MoS₂, WS₂ and MoSe₂.

A13. The substrate, use or method according to any one of Embodiments A2-A5 or A7-A12, wherein the substrate is selected from: metals; natural or synthetic fibres, preferably cotton or nylon fibres, more preferably cotton fibres; thermoplastic and thermosetting polymers; ceramics; electronic circuit components, such as integrated circuit chips; and currency, such as polymeric or paper banknotes; with the proviso that the substrate is not a metal when the Raman-detectible composition is homogeneously dispersed in the bulk of the substrate.

A14. The substrate, use or method according to Embodiment A13, wherein the substrate is a natural or synthetic fibre, preferably a cotton or nylon fibre, more preferably a cotton fibre.

A15. The substrate, use or method according to Embodiment A13, wherein the Raman-detectible composition is homogeneously dispersed in the bulk of the substrate, preferably wherein the substrate is a thermoplastic polymer.

A16. The formulation according to any one of Embodiments A1 or A7-A12, which comprises a Pickering emulsion stabilised by the two or more Raman-active 2D materials.

A17. The formulation according to any one of Embodiments A1 or A7-A12, wherein the binder is paraffin wax or a polymer, preferably wherein the polymer is selected from water soluble polymers; cellulose esters; thermoplastic polyurethanes; poly(methyl methacrylate); poly(methyl methacrylate-co-butyl methacrylate) [PMMA-co-BA]; polyvinyl acetate; natural rubber; and synthetic poly(isoprene), more preferably wherein the polymer is a water soluble polymer selected from: polyvinylpyrrolidone (PVP), polyvinyl alcohol (PVOH), dextran, poly(acrylic acid sodium salt), poly(ethylene glycol), poly(methylacrylic acid sodium salt), pullulan, water soluble cellulose derivatives and combinations thereof.

A18. An ink comprising a formulation according to any one of Embodiments A1, A7-A12, A16 or A17, and a liquid carrier, preferably wherein the binder is a polymer.

A19. The ink according to Embodiment A18, wherein the liquid carrier is water.

A20. The method for analysing a substrate or formulation for the presence of a Raman-detectible composition according to any one of Embodiments A5 or A7-A12, wherein the analysis comprises determining the relative amounts of the different 2D materials.

B1. A method of generating a code based on the nanoplatelet-content of a material, the method comprising:

a) measuring and obtaining the Raman spectrum of the material, wherein the material comprises two or more types of nanoplatelets with differing chemical compositions;

b) comparing the obtained Raman spectrum with reference data for each of the types of nanoplatelets in order to determine the presence, and optionally the quantities, of the two or more types of nanoplatelets;

c) generating a code based on the presence, and optionally the quantities, of the two or more types of nanoplatelets.

B2. A method according to embodiment B1 wherein the nanoplatelets are selected from graphite nanoplatelets, boron nitride nanoplatelets and 2D layer transition metal dichalcogenides (e.g. MoS₂, NbSe₂ and WS₂).

B3. A method according to embodiment B1 or B2 wherein the material comprises three or more or four or more types of nanoplatelets with differing chemical compositions.

B4. A method according to any one of embodiments B1 to B3 wherein the reference data is a characteristic Raman scattering wavelength (or “Raman Shift”) of the types of nanoplatelets.

B5. A method according to any one of embodiments B1 to B4 wherein the code is a multi-digit numerical code wherein each digit of the code corresponds to the quantity of a type of nanoplatelet present within the material.

B6. A method of verifying the authenticity of an article, the method comprising:

a) generating a code according to a method according to any one of embodiments B1 to B5;

b) comparing the generated code with a known code to determine the authenticity of the article.

B7. A method according to any one of embodiments B1 to B6 which is a computer-implemented method.

B8. An apparatus for verifying the authenticity of articles, the apparatus comprising:

(a) a Raman spectrometer, the spectrometer comprising a laser light source and a detector;

(b) an electronic data store for storing known Raman reference data of two or more types of nanoplatelets;

(c) an electronic data processor for comparing the Raman spectrum obtained by the spectrometer and the Raman spectra in the electronic data store; and

(d) an output device for indicating to the user either:
i) a code derived from the obtained Raman spectrum; or
ii) an indication of the authenticity of the article.

B9. A composition for use as a Raman-readable tag, the composition comprising: two or more nanoplatelets selected from graphene, boron nitride and transition metal dichalcogenides and one or more binders or solvents.

B10. A composition according to embodiment B9 comprising a polymer binder (e.g. a PVA polymer).

B11. A method of storing a code within a material, the method comprising adding two or more types of nanoplatelets to the material in predefined amounts so that the relative amounts of each type of nanoplatelet form a code.

B12. A method of applying a Raman-readable tag to an article, the method comprising incorporating or adding a composition according to any one of embodiments B9 to B10 to an article.

The term “nanoplatelets” as used herein refers to nanoparticles which consist of small stacks of a layered 2D material. The nanoplatelets typically have a thickness of less than 30 nm, for example less than 20 nm. As such, a “nanoplatelet” is an example of a 2D material.

The compositions described above may comprise two or more “types” of nanoplatelets. A “type” of nanoplatelet refers to nanoplatelets sharing the same chemical composition. Thus, two or more “types” of nanoplatelets means that there are two or more different Raman-active 2D materials present.

Two Raman-active 2D materials are generally “different” or different “types” if they have a different chemical composition (e.g. graphene and boron nitride).

1. A Raman-detectible composition comprising two or more different Raman-active 2D materials.

2. The Raman-detectible composition of claim 1, wherein the Raman-detectible composition comprises three or more different Raman-active 2D materials.

3. A formulation comprising the Raman-detectible composition of claim 1 and a binder.

4. A substrate comprising the Raman-detectible composition according to claim 1, wherein:
(i) the Raman-detectible composition is homogeneously dispersed within the substrate, and wherein the substrate is not a metal; or
(ii) the Raman-detectible composition is on the surface of the substrate, optionally wherein the Raman-detectible composition also comprises a binder.

5. (canceled)

6. A method for tagging a substrate with the Raman-detectible composition of claim 1, the method comprising:
(i) dispersing the Raman-detectible composition within the substrate, wherein the substrate is not a metal; or
(ii) applying the Raman-detectible composition to the surface of the substrate, optionally wherein the Raman-detectible composition also comprises a binder.

7. A method for analysing a substrate or formulation for the presence of the Raman-detectible composition of claim 1, the method comprising:
(i) subjecting the substrate or formulation to Raman spectroscopy, and
(ii) analysing the Raman spectrum for the presence of a Raman signal that is characteristic of the Raman-detectible composition.

8. The method of claim 7, wherein step (ii) comprises comparing the Raman spectrum obtained in step (i) to that of a reference composition, where the reference composition is the same as the Raman-detectible composition comprising two or more different Raman-active 2D materials which is being tested for.

9. (canceled)

10. The method of claim 7, wherein the substrate or formulation comprises the Raman-detectible composition.

11. A method comprising:
(a) measuring and obtaining the Raman spectrum of a material comprising the Raman detectible composition of claim 1;
(b) comparing the obtained Raman spectrum with reference data for each of the two or more different 2D materials in order to determine the presence, and optionally the quantities, of the two or more different 2D materials; and
(c) generating a code based on the presence, and optionally the quantities, of the two or more different 2D materials.

12. (canceled)

13. The Raman-detectible composition according to claim 1, wherein the 2D materials are independently selected from: graphene, graphene oxide, reduced graphene oxide, borophene, germanene, silicene, stanene, phosphorene, bismuthene, hexagonal boron nitride (h-BN), 2D silicates, layered double hydroxides (LDH) 2D perovskites, transition metal dichalcogenides (TMDs), MoCl₃, black phosphorus, Cr₂S₃, SnO, SnSe₂, Ga₂S₃, CoO, GaPO₄, InN, FeSe, indium tin oxide (ITO), GaN, GaS, Bi₂O₂Se, CuS, GaSe, GaTe, Bi₂Te₃, Bi₂Se₃, Bi₂TeS₂, MoO₂, MoO₃, BiOCl, V₂O₅, talc, InO, InSe, InS₃, GeS and GeSe.

14. (canceled)

15. The Raman-detectible composition according to claim 1, wherein the 2D materials are independently selected from: graphene, graphene oxide, reduced graphene oxide, h-BN, and TMDs.

16. (canceled)

17. The Raman-detectible composition according to claim 1, wherein the 2D materials are independently selected from: graphene, graphene oxide, h-BN, MoS₂, WS₂ and MoSe₂.

18. The substrate according to claim 4, wherein the substrate is selected from: metals; natural or synthetic fibres; thermoplastic and thermosetting polymers; ceramics; electronic circuit components; and currency; with the proviso that the substrate is not a metal when the Raman-detectible composition is homogeneously dispersed in the bulk of the substrate.

19. The substrate according to claim 4, wherein the substrate is a natural or synthetic fibre.

20. The substrate according to claim 4, wherein the Raman-detectible composition is homogeneously dispersed in the bulk of the substrate.

21. The formulation according to claim 3, which comprises a Pickering emulsion stabilised by the two or more Raman-active 2D materials.

22. The formulation according to claim 3, wherein the binder is paraffin wax or a polymer; cellulose esters; thermoplastic polyurethanes; poly(methyl methacrylate); poly(methyl methacrylate-co-butyl methacrylate) [PMMA-co-BA]; polyvinyl acetate; natural rubber; synthetic poly(isoprene); and thermosetting polymers.

23. The formulation according to claim 3, wherein the binder is a polymer selected from: polyvinylpyrrolidone (PVP); polyvinyl alcohol (PVOH); dextran; poly(acrylic acid sodium salt); poly(ethylene glycol); poly(methylacrylic acid sodium salt); pullulan; cellulose derivatives; cellulose esters; polyurethanes; poly(methyl methacrylate); poly(methyl methacrylate-co-butyl methacrylate) [PMMA-co-BA]; polyvinyl acetate; natural rubber; synthetic poly(isoprene); thermosetting polymers; polypropylene oxide (PPO), polyaniline (PANI); and poly N-isopropylacrylamide (PNIPAAm), polyacrylate.

24. An ink comprising the formulation according to claim 3 and a liquid carrier.

25. (canceled)

26. (canceled)

27. An apparatus for verifying the authenticity of an article, the apparatus comprising:
(a) a Raman spectrometer, the spectrometer comprising a laser light source and a detector;
(b) an electronic data store for storing known Raman reference data of two or more different Raman-active 2D materials;
(c) an electronic data processor for comparing the Raman spectrum obtained by the spectrometer and the Raman spectra in the electronic data store; and
(d) an output device for indicating to the user either:
(i) a code derived from the obtained Raman spectrum; or
(ii) an indication of the authenticity of the article.
